(19) United States
(12) Patent Application Publication
(10) Pub. No.: US 2003/0202507 A1
(43) Pub. Date: Oct. 30, 2003

(54) VoIP network system

(76) Inventors: Minoru Nishida, Fukuoka (JP); Mari Akagi, Fukuoka (JP); Masami Ohta, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/349,870

(22) Filed: Jan. 23, 2003

(30) Foreign Application Priority Data
Apr. 30, 2002 (JP) 2002-128050

(51) Int. Cl. H04L 12/66

(52) U.S. Cl. 370/352

(57) ABSTRACT

A VoIP network system includes a module controlling a transmission of a priority control indication corresponding to a call control signal for every call and to priority control information preset for providing a VoIP-based voice communication service in a way that specifies a priority control target call related to a specified voice session, and a module giving a priority control indication about a voice packet of the priority control target call to each of network elements, configuring an IP network, for forwarding the voice packet.

### BACKGROUND OF THE INVENTION

The present invention relates generally to a VoIP (Voice over Internet Protocol) network system for forwarding (which includes transmitting and switching) voice packets over an IP (Internet Protocol) network, and more particularly to a VoIP network system for providing value-added services by preferentially controlling a call related to a specified voice session.

Local and intermediate- and long-distance carriers (communication service providers) have confronted with sever competitions in order to acquire their customers over the recent years, and their indispensable conditions are reducing the equipment/operation costs and providing attractive value-added services.

Each of the carrier's schemes to, first of all, reduce the equipment/operation costs by utilizing the IP network based on VoIP technology as a voice/data integrated network in order to fulfill the above conditions.

A VoIP network system that each carrier schemes to configure includes, as will be explained later on, an existing telephone network such as PSTN (Public-Switched Telephone Network), media gateways (MG), a softswitch (SSW) for controlling the media gateways on the basis of H.248 (MEGACO: Media Gateway Control) protocol standardized by IETF (Internet Engineering Task Force) and ITU-T (International Telecommunications Union Standardization Sector), and an OSS (Operation and Support System) serving as a maintenance/operation device for handling maintenance and operation of the network elements (network configuring elements) such as the media gates and the softswitch.

This VoIP network system is capable of executing a call process for forwarding an integrated set of voice and data, basically based on a premise of ensuring a merit of cost performance. Therefore, the VoIP network system does not necessarily prepare equipment capable of guaranteeing QoS (Quality of Service) about a transmission delay and a bandwidth enough to respond to an assumable voice traffic.

Further, there are proposed technologies of setting static filtering conditions and priority conditions for a router as one of the IP network configuring elements in order to ensure an enhanced quality of voice as a whole in the VoIP network system.

A first technology is, as disclosed in Japanese Patent Laying-Open Publication No. 2001-16254 (Document 1: Packet Forwarding/Receiving Method by Voice-Oriented Router), that a router as a network element judges whether a packet is a packet for voice in the case of routing the packet and, if so, preferentially processing this voice packet.

A second technology is, as disclosed in Japanese Patent Laying-Open Publication No. 2000-34985 (Document 2: Packet Forwarding Device), that if a packet outputted after undergoing a routing process, a filtering process and a priority control process in a main processing unit meets a certain fitting condition and is forwarded bypassing the subsequent packet main processing unit, thus effecting the priority control.

A further technology for guaranteeing QoS in the IP network is, as disclosed in Japanese Patent Laying-Open Publication No. 11-12503 (Document 3: Network System and Network Device), that only when a connection management server judges that communication quality contained as a piece of information on a connection setting request can be guaranteed when establishing a connection, this connection is established, thereby guaranteeing the communication quality. This technology schemes to ensure QoS by dynamically changing the network policy.

As described above, each carrier can provide an end user which might be simply called a user or a subscriber) with the service at a low communication fee by reducing the equipment/operation costs, wherein the network is configured as an IP-based network, i.e., as a voice/data integrated network.

On the other hand, there can be considered demands for value-added services, wherein the end user requires a high-level quality only of a specified voice communication (specified call) such as business negotiations and a support service and only of a voice communication (emergency call) such as reporting to a police station and a fire station.

Providing this category of value-added services requires an algorithm for changing a priority of the voice packet for every call by using pieces of source/destination (call originating/receiving) information, subscriber information and so on. According to the technologies disclosed in the documents 1 and 2, however, a rise of the priority of the voice packet itself involves statically setting this condition in the network element, and the condition can not be set for every call.

Further, the technology disclosed in the document 3 has the scheme of dynamically changing the network policy and is, the policy change aiming at restraining the traffic over the network, still incapable of the call-by-call priority control taking the source/destination information and the subscriber information into account.

Accordingly, there arises a problem inherent in the conventional VoIP network systems, wherein it is impossible to actualize the voice communication services requiring the call-by-call flexible value added without any increase in the operation cost.

### SUMMARY OF THE INVENTION

It is a primary object of the present invention to provide a technique capable of actualizing a call-by-call flexible voice communication service over an IP network as a voice/data integrated network without any increase in equipment/operation costs.

It is another object of the present invention to provide a technique capable of providing a VoIP-based voice communication service by preferentially processing a priority control target call related to a specified voice session.

To accomplish the above objects, a first VoIP network system of the present invention includes a module controlling a transmission of a priority control indication corresponding to a call control signal for every call and to priority control information preset for providing a VoIP-based voice communication service in a way that specifies a priority control target call related to a specified voice session, and a module giving a priority control indication about a voice packet of the priority control target call to each of network elements, configuring an IP network, for forwarding the voice packet.

A second VoIP network system of the present invention provides a VoIP-based voice communication service by forwarding a voice packet over an IP network, the system including a module judging whether a call is a priority control target call related to a specified voice session on the basis of call originating number information contained in a call control signal transmitted from a source network accommodating a call originating terminal, and, when judging that the call is the priority control target call, controlling a transmission of a priority control indication, a module searching storage data for managing the priority control with the indicated number information used as a key, and transmitting a signal for making a priority control request about IP session information used for the voice session of the priority control target call, and a module giving a control indication for operating network elements of the IP network on the basis of the storage data for control of session priority change when receiving a priority control request signal for the priority control target call.

A third VoIP network system of the present invention may further include a module selecting, when judging that the call is the priority control target call, high-priority IP session information by searching the storage data for managing preferential IP sessions in an environment where a high priority is set in a specified item of IP session information in the network elements, and a module indicating the network element to establish a path connection in the IP network on the basis of the selected IP session information.

A fourth VoIP network system of the present invention may further include a module transmitting subscriber information in the call originating number information contained in the call control signal in order to give the priority control indication for the priority control target call, and a module making a judgement about the priority control target call by searching the storage data for a priority control management with the received subscriber information used as a key.

A fifth VoIP network system of the present invention may further include a first storage module managing a priority control identifier for identifying the priority control target call, a second storage module managing a priority control implementation status in a way that maps this status to the priority control identifier for every call, a setting/searching module setting and searching management data of the storage module when originating a call and when terminating the call, a module booted by the setting/searching module when originating the call and when terminating the call, controlling an acquisition and a transmission of the priority control identifier, and controlling a transmission of a priority control terminating indication when terminating the call, a third storage module managing a mapping of a priority change to the network element on the basis of the received priority control identifier, a module setting management data on the third storage module when receiving the priority control indication, specifying the network element on the basis of the received priority control identifier and the priority control identifier management data stored on the third storage module when receiving the priority control terminating indication, and extracting an initial priority control policy of the specified network element from storage data for managing a network architecture, and a module effecting a session priority change for making a priority policy change request when receiving the priority control terminating indication.

A sixth VoIP network system of the present invention may further include a module booted when making a change due to a maintenance with respect to the priority policy related to the IP session information and, if the indicated network element is in the process of the priority control, managing a priority control identifier used for sending this purport back, and a module judging whether a requested maintenance-based change can be done by querying the priority control identifier management module, and changing only the network architecture management storage data when on the implementation of the priority control.

A seventh VoIP network system of the present invention may further include a management module judging whether a voice packet quality exceeds a preset quality threshold value by referring to priority control threshold value data when notified of the voice packet quality of the priority control target call undergoing the implementation of the priority control that is transmitted from the network element having a function of notifying the voice packet quality, determining an operation of the preset network element by referring to a priority control decrease time operational definition data, and sending a content of this operation back, and a module notifying the management module of the voice packet quality of which the network element has notified, and controlling a priority control decrease time operation of the network element on the basis of the operation content sent back.

According to the present invention, each time the voice session occurs and terminates, only the priority of the voice communication packet related to this session can be automatically changed.

This scheme makes it possible to provide a value-added service such as enhancing QoS in accordance with a call setting condition as in the case of a specified call such as business negotiations and a support service, and an emergency call such as reporting to a police station and a fire station without any increase in maintenance/operation costs.

Moreover, the call-by-call high-quality voice communication service corresponding to the subscriber information can be provided, and hence the present invention can be applied to a case where an intranet with subscribers demanding a fixed level of voice quality can be actualized in a network provided by the carrier.

From what has been described so far, it is feasible to provide the call-by-call flexible service in a way that restrains the IP network maintenance/operation costs down to the minimum, so that the carriers can offer more of menus of the voice communication services provided to the end users. This can lead to an expectation of such an effect that the carriers come to gain increases both in the competitiveness in terms of cost performance and in competitiveness based on providing the value-added services.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a block diagram showing an architecture of a VoIP network system in one embodiment of the present invention;

FIG. 2 is an explanatory view showing a relationship between an OSS and network elements in FIG. 1;

FIG. 3 is an explanatory view showing operations of the improving target VoIP network system;

FIG. 4 is an explanatory view showing an operation of an improving target softswitch;

FIG. 5 is an explanatory view showing an operation of an improving target OSS;

FIG. 6 is an explanatory view showing an outline of a configuration and an operation of the softswitch in FIG. 1;

FIG. 7 is an explanatory view showing an outline of a configuration and an operation of the OSS in FIG. 1;

FIG. 8 is an explanatory view showing a first specific operational example in the system shown in FIG. 1;

FIG. 9 is an explanatory view showing the first specific operational example in the system shown in FIG. 1;

FIG. 10 is an explanatory view showing a second specific operational example in the system shown in FIG. 1;

FIG. 11 is an explanatory view showing a third specific operational example in the system shown in FIG. 1;

FIG. 12 is an explanatory view showing a fourth specific operational example in the system shown in FIG. 1;

FIG. 13 is an explanatory view showing the fourth specific operational example in the system shown in FIG. 1;

FIG. 14 is an explanatory view showing a fifth specific operational example in the system shown in FIG. 1;

FIG. 15 is an explanatory view showing a sixth specific operational example in the system shown in FIG. 1;

FIG. 16 is a diagram showing a specific example of a priority control management data storage module shown in FIG. 6;

FIG. 17 is a diagram showing a specific example of a subscriber information priority control management data storage module shown in FIG. 6;

FIG. 18 is a diagram showing a specific example of an MG priority IP session management data storage module shown in FIG. 6;

FIG. 19 is a diagram showing a specific example of a session priority change control data storage module shown in FIG. 7;

FIG. 20 is a diagram showing a specific example of a priority control saving data storage module shown in FIG. 6;

FIG. 21 is a diagram showing a specific example of a priority control identifier management data storage module shown in FIG. 6;

FIG. 22 is a diagram showing a specific example of the priority control identifier management data storage module shown in FIG. 7;

FIG. 23 is a diagram showing a specific example of a priority control threshold value data storage module shown in FIG. 6; and

FIG. 24 is a diagram showing a specific example of a priority control decrease time operational definition data storage module shown in FIG. 6.

### DETAILED DESCRIPTION OF THE PREFERRED EMBODIMENTS

Next, embodiments of the present invention will hereinafter be discussed with reference to the accompanying drawings.

[Architecture of VoIP Network System]

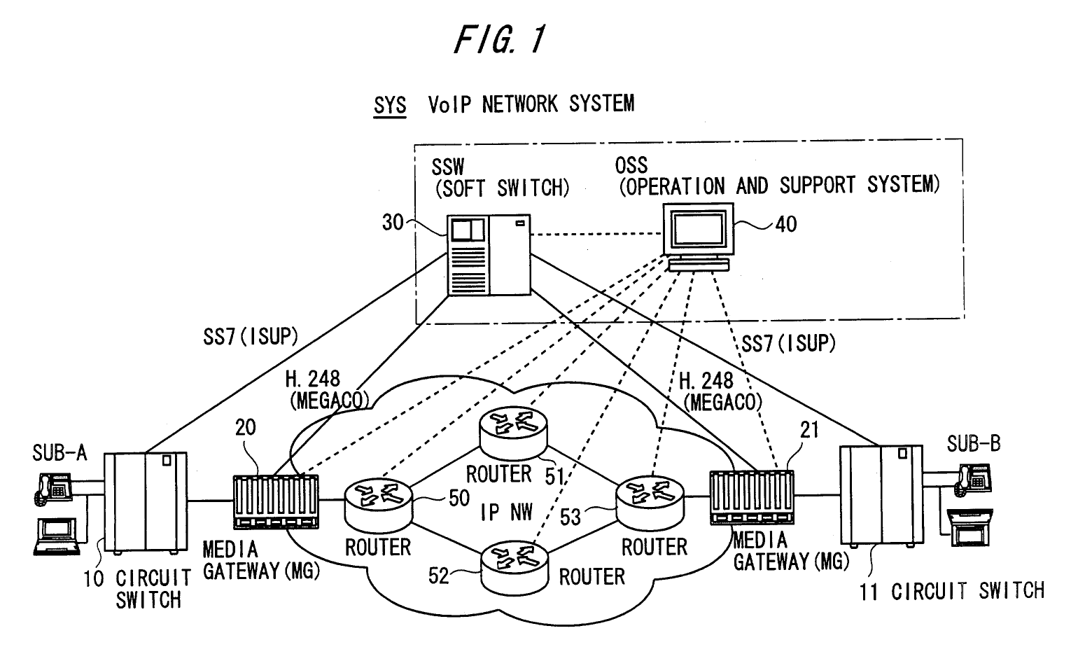

FIG. 1 is a view showing a system architecture in one embodiment of the present invention. Referring to FIG. 1, a VoIP network system SYS includes circuit switches 10, 11 installed on an existing telephone network such as a public-switched telephone network, media gateways (MGs) 20, 21 that connect these circuit switches 10, 11 to an IP network IPNW and each have a media conversion function, a softswitch (SSW) 30 serving as a call priority control device for controlling VoIP calls according to H.248 (MEGACO: Media Gateway control) protocol on which the MGs 20, 21 are standardized by ITU-T, and an OSS (Operation and Support System) 40 serving as a maintenance operation device/policy controller for handling maintenance and operation of network elements such as the MGs 20, 21 and the SSW 30 on the IP network IPNW.

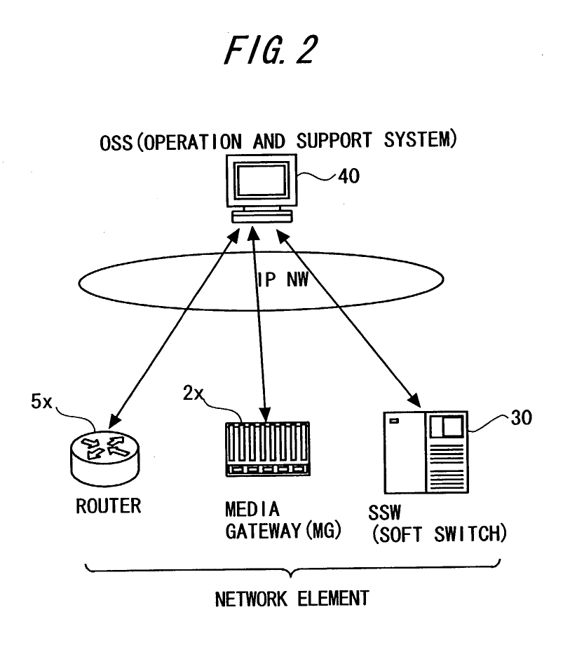

The IP network IPNW in this VoIP network system SYS accommodates routers 50, 53 as edge nodes (ingress and egress nodes) and routers 51, 52 as relay nodes. As shown in FIG. 2, these routers 50 through 53 are, as viewed from the OSS 40, defined as the network elements (network configuring elements) of the IP network IPNW together with the MGs 20, 21 and the SSW 30.

A scheme of this VoIP network system SYS is that the MGs 20, 21, the IP network IPNW including the routers 50 through 53 and the SSW 30 in the system SYS take a logically 3-tiered architecture with respect to services provided over a voice-data integrated network.

Further, the circuit switches 10, 11 accommodate subscriber terminals SUB-A, SUB-B respectively, and are connected to the SSW 30 via a common line signal network (unillustrated).

Each of the subscriber terminals SUB-A, SUB-B used by subscribers is constructed of a telephone (voice communication terminal) and a personal computer (information terminal). Note that each of the subscriber terminals SUB-A, SUB-B may be a single unit or a composite unit of a fixed telephone terminal a mobile telephone terminal a personal computer and a PDA (Personal Digital Assistant) on condition that it has a communication function, an information input function, an information display function and an information specifying function.

[Object of Improvement]

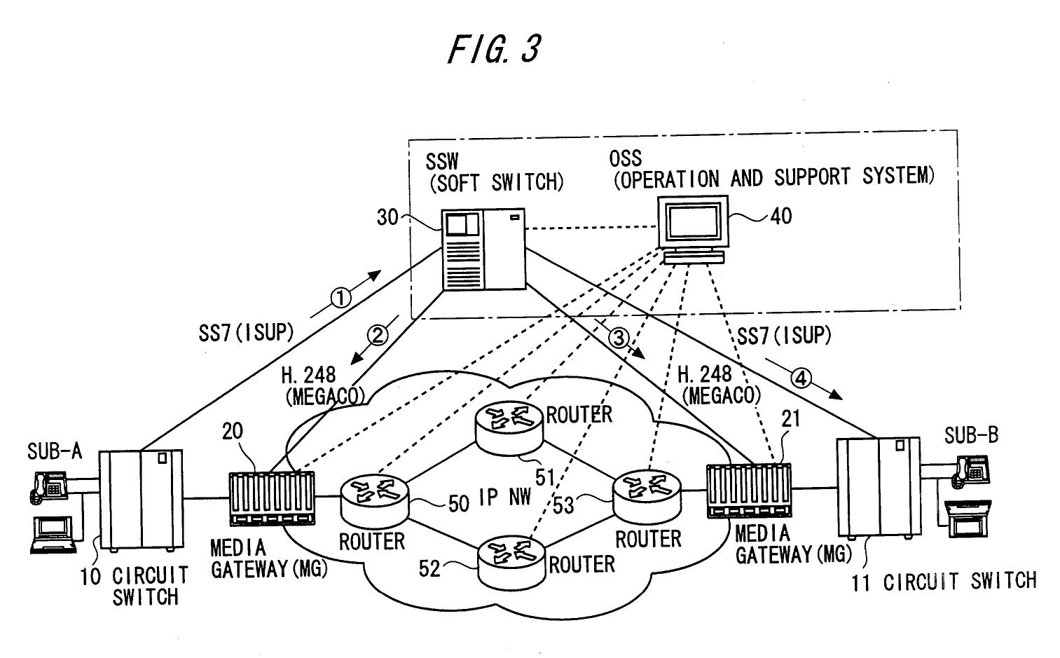

An object of improvement according to the present invention will hereinafter be described with reference to FIGS. 3, 4 and 5 in combination.

Referring first to FIG. 3, circled numerals 1 through 4 show a synopsis of a sequence (steps) of flow of control signals, starting with originating a call in the VoIP network system SYS and ending with completing a call connection.

In this example, the subscriber terminal SUB-A is a call originating party, while the subscriber terminal SUB-B is a call receiving party. Therefore, the circuit switch 10 transmits to the SSW 30 a call originating signal as a call control signal carried over Common Channel Signaling (CCS) (which is defined as a network) using SS7 (Signaling System 7 (No. 7)) (which is defined as a protocol) under ISUP (ISDN User Part) protocol (step 1).

The SSW 30 receiving the call originating signal, after executing a predetermined process that will be explained later on, transmits an indication of a path connection to the source MG 20 according to H.248 (MEGACO) protocol (step 2).

The SSW 30, when receiving a result of the connection from the caller MG 20, transmits the indication of the path connection to the MG 21 as a called party (callee) according to H.248 (MEGACO) protocol (step 3).

Further, the SSW 30, when receiving a result of the connection from the destination MG 21, transmits the indication of the path connection to the circuit switch 11 as a callee according to SS7 over the CCS network (step 4).

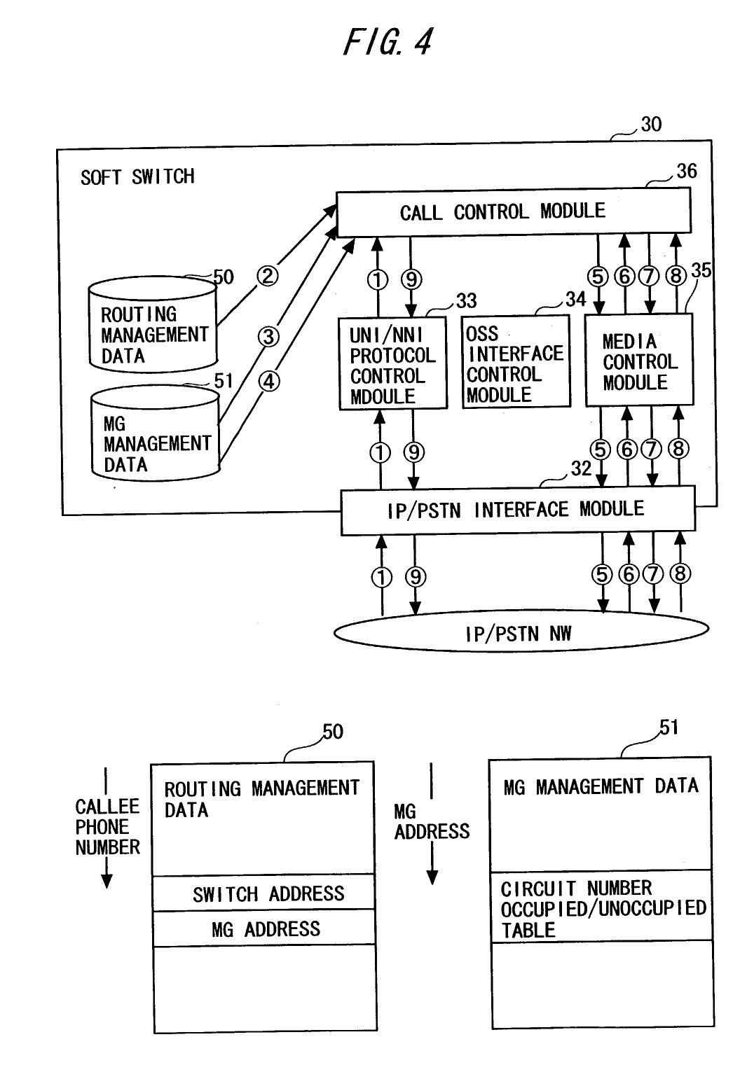

Next, FIG. 4 shows a detailed configuration of the softswitch SSW 30 in the VoIP network system SYS. Referring to FIGS. 3 and 4 in combination, the circled numerals 1 through 9 in FIG. 4 show a detailed flow of the control signals when in a calling process in the SSW 30.

An IP/PSTN interface module 32 (corresponding to a communication module of the present invention) receives a call originating signal as a call control signal SS7 (ISUP) transmitted based on SS7 (ISUP) over the CCS network from the public-switched telephone network PSTNNW accommodating the circuit switch 10. A call control module 36 receives this call originating signal via a UNI/NNI (User Network Interface/Network Node Interface) protocol control module 33 (step 1).

The call control module 36 receiving the call originating signal searches a routing management data storage module 50, wherein a piece of information (a source switch address) contained in this call originating signal and specifying the caller-side circuit switch 10 is used as a key, thereby determining the source MG 20 from a source MG address mapping to this MG 20 (step 2).

Further, the call control module 36 analyzes a calleephone number (a phone number of the called party) contained in the call originating signal. Then, the call control module 36 searches the routing management data storage module 50 and thus determines the callee-side circuit switch 11 (a receiving switch address) and the destination MG 21 (a destination MG address) (step 3).

Further, the call control module 36 searches an MG management data storage module 51 with the destination MG address used as a key, thereby determining an unoccupied line (path) between the callee-side circuit switch 11 and the destination MG 21 (step 4).

The call control module 36, after executing these processes, transmits the indication of the path connection based on H.248 (MEGACO) protocol to the source MG 20 via a media control module 35 and the IP/PSTN interface module 32 (step 5).

The call control module 36, when receiving a result of the connection from the source MG 20 via the IP/PSTN interface module 32 and the media control module 35 (step 6), transmits the indication of the path connection based on H.248 (MEGACO) protocol to the destination MG 21 via the media control module 35 and the IP/PSTN interface module 32 (step 7).

Further, the call control module 36, when receiving a result of the connection from the destination MG 21 via the IP/PSTN interface module 32 and the media control module 35 (step 8), transmits the indication of the path connection based on SS7 (ISUP) in the CCS network to the callee-side circuit switch 11 via the UNI/NNI protocol control module 33 and the IP/PSTN interface module 32 (step 9).

The above-described call processing control function in the SSW 30 enables the subscriber terminals SUB-A and SUB-B to enjoy a VoIP service as a voice communication service via the IP network IPNW.

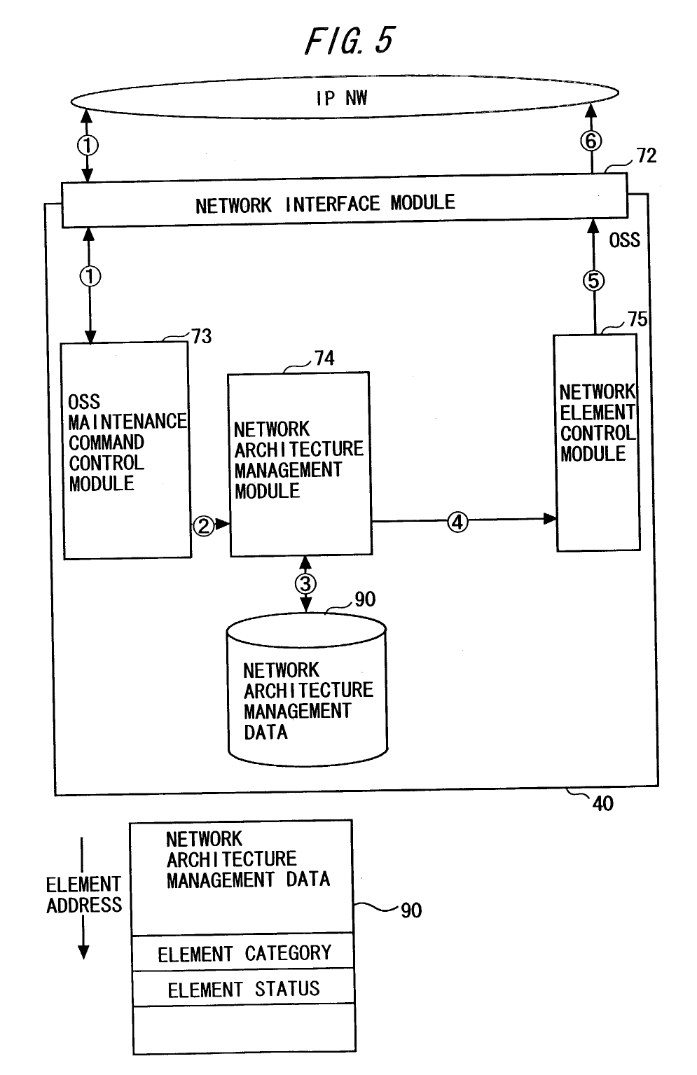

Next, FIG. 5 shows a detailed configuration of the OSS 40 in the VoIP network system SYS. Referring to FIGS. 5 and 3 in combination, the circled numerals 1 through 6 in FIG. 5 show a detailed flow of the control signals in a maintenance command process in the OSS 40.

In the OSS 40, an OSS maintenance command control module 73 receives a policy change indication command of the network element from the IP network IPNW via a network interface module 72 (corresponding to a communication module of the present invention) (step 1).

The OSS maintenance command control module 73, when receiving the policy change indication command, analyzes a content of this command and boots a network architecture management module 74 to change a policy (step 2).

The network architecture management module 74 searches a network architecture management data storage module 90 in a way that uses, as keys, network element addresses contained in a boot content (a boot message), then collates these network elements with pieces of network architecture management data (element types and element statuses), requests, if possible of processing a content of the policy change, a network element control module 75 to change a policy of these network elements, and stores the changed policy on the network architecture management data storage module 90 (steps 3, 4).

The network element control module 75, based on the boot content (boot message), executes a policy changing step of the network element (step 5). The network interface module 72 transmits over the IP network IPNW the policy change content (message) received from the network element control module 75 (step 6).

With this process thus executed, the policy change is applied to the network elements such as the MGs 20, 21, the routers 50 through 53 and the SSW 30.

In the VoIP network system SYS described above, the IP network IPNW is configured as the voice/data integrated network, whereby the voice communication services can be provided to the subscriber at a low communication fee by reducing the equipment/operation costs.

In a case where the subscriber requires a high-level quality not always but only of specified voice communications such as business negotiations, a support service etc and also requires the high-level quality only of voice communications such as reporting to a police station and a fire station, an algorithm for changing the priority of the voice packet for ever call is needed for providing such an value-added service.

[Architecture of Softswitch SSW]

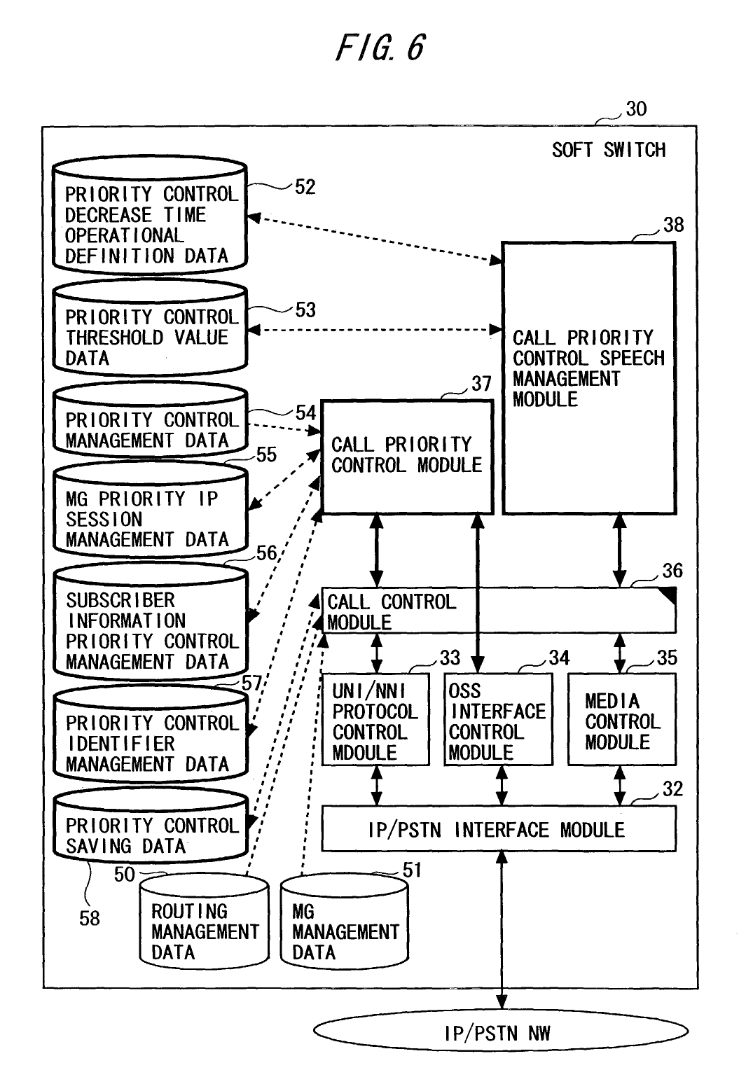

The SSW 30 as the call priority control device in the VoIP network system SYS shown in FIG. 1 includes, as illustrated in FIG. 6, the IP/PSTN interface module 32, the UNI/NNI protocol control module 33, the OSS interface control module 34, the media control module 35, the call control module 36, the routing management data storage module 50 and the MG management data storage module 51 in order to execute the call process described above in a way that interworks with the circuit switches 10, 11 installed on the public-switched telephone network PSTNW, the MGs 20, 21 installed on the IP network IPNW.

Herein, the IP/PSTN interface module 32 executes a process of accepting transmissions/receipts of a variety of signals to and from the circuit switches 10, 11 and the MGs 20, 21. This is described such that the IP/PSTN interface module 32 transmits and receives the signals to and from the public-switched telephone network PSTNNW or the IP network IPNW unless specified otherwise in the following discussion.

The UNI/NNI protocol control module 33 has a signal control function based on SS7 (in the Common Channel Signaling) with the public-switched telephone network PSTNNW, and a control function based on call control protocol H. 323 with the IP network IPNW or based on SIP (Session Initiation Protocol). The OSS interface control module 34 accepts a status-of-system notification and a command request from the OSS 40.

The media control module 35 has a control function of controlling the MGs 20, 21. The call control module 36 executes call control (call setting, a transition of status, releasing) in response to the signals transmitted from the subscriber terminals SUB-A and SUB-B.

The routing management data storage module 50 is stored with routing management data for determining a route to a connection destination on the basis of the call setting signal (the callee phone number) received (see FIG. 4). An MG management data storage module 51 is stored with MG management data for managing line states (unoccupied/occupied) between the circuit switches 10, 11 and the MGs 20, 21 in the public-switched telephone network PSTNNW (see FIG. 4).

Further, the SSW 30, for executing a call priority process in cooperation with the components for carrying out the call process described above, further includes a call priority control module 37, a call priority control speech management module 38, a priority control decreasing time operational definition data storage module 52, a priority control threshold data storage module 53, a priority control management data storage module 54, an MG priority IP session management data storage module 55, a subscriber information priority control management data storage module 56, a priority control identifier management data storage module 57 and a priority control saving data storage module 58. Functions of these further components will be clarified in the following discussion on the operations.

[Configuration of Policy Controller OSS]

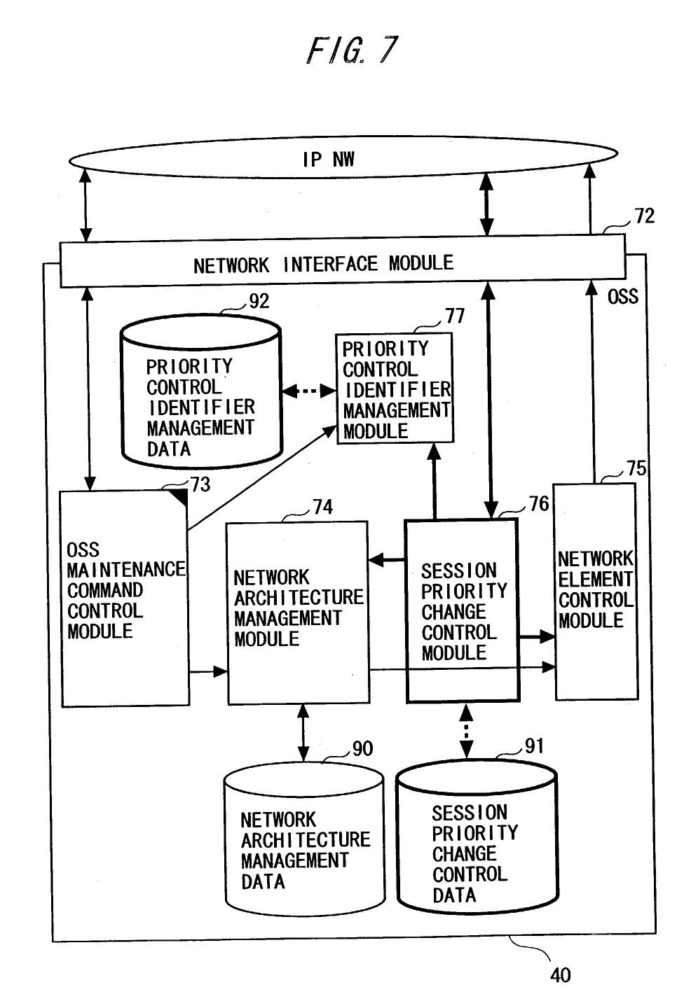

The OSS 40 categorized as the policy controller/maintenance operation device in the VoIP network system SYS shown in FIG. 1 includes, as shown in FIG. 7, a network interface module 72, an OSS maintenance command control module 73, a network architecture management module 74, a network element control module 75 and a network architecture management data storage module 90 in order to execute the policy change in a way that interworks with the MGs 20, 21, the routers 50 through 53 and the SSW 30 defined as the network elements respectively located in the IP network IPNW.

Herein, the network interface module 72 executes a process of accepting transmissions/receipts of a variety of signals to and from the MGs 20, 21, the routers 50 through 53 and the SSW 30. This is described such that the network interface module 72 transmits and receives the signals to and from the IP network IPNW unless specified otherwise in the following discussion.

The OSS maintenance command control module 73 executes predetermined control in response to a maintenance command received. The network architecture management module 74 performs an addition and a change of the architecture management of the IP network IPNW and displays a status of the IP network.

The network element control module 75 sends a control signal to the network element in response to the command request. The network architecture management data storage module 90 is stored with information such as architecture management data of each network element and routing data (see FIG. 5).

Further, the OSS 40, for executing the policy change related to the call priority process in cooperation with the components for carrying out the policy change described above, further includes a session priority change control module 76, a priority control identifier management module 77, a session priority change control data storage module 91 and a priority control identifier management data storage module 92. Functions of these further components will be clarified in the following discussion on the operations.

[Outline of Operations of VoIP Network System]

Referring next to FIGS. 1, 6 and 7 in combination, outlines of various operations in the call priority process and the policy change process subsequent thereto in the VoIP network system SYS will be explained, and the functions of the improved softswitch 30 and OSS 40 will be synopsized based on this explanation.

<First Operation>

The call control module 36 of the SSW 30 receives a call control signal from the public-switched telephone network PSTNNW via the IP/PSTN interface module 32 and the UNI/NNI protocol control module 33.

The call control module 36 searches the routing management data storage module 50 and the MG management data storage module 51, thus determines the MG 20 as a source MG and the MG 21 as a destination MG, and executes the path connection control.

The call priority control module 37 booted by the call control module 36 gives an indication (priority control indication) to the OSS 40 via the OSS interface control module 34 and the IP/PSTN interface module 32.

The OSS 40 receives the priority control indication transmitted from the SSW 30 via the IP network IPNW and the network interface module 72. In this OSS 40, the session priority change control module 76 gives the priority control indication about a priority control target voice packet to each of the network elements via the network element control module 75 and the network interface module 72.

This scheme makes it possible to provide the voice communication services over the IP network IPNW, i.e., to provide a voice quality enhancement function responding to the priority control target call in the VoIP service.

<Second Operation>

The following is amore detailed description of the example of the first operation. The call control module 36 of the SSW 30 receives the call originating signals as the call control signal from the public-switched telephone network PSTNNW via the IP/PSTN interface module 32 and the UNI/NNI protocol control module 33.

The call control module 36 determines, based on source circuit switch information and a result of phone number analysis, the source/destination MGs by searching the routing management data storage module 50 and the MG management data storage module 51, and executes the path connection control.

The call priority control module 37 booted by the call control module 36 searches the priority control management data storage module 54 in a way that uses as a key a callee phone number (a phone number of the called party) for specifying the callee subscriber terminal SUB-B, and, if judging that the call is a priority control target call, i.e., a call specifying the business negotiations, the support service etc and an emergency call such as reporting to the police station, the fire station etc, gives the priority control indication to the OSS 40 via the OSS interface control module 34 and the IP/PSTN interface module 32.

The OSS 40 receives the priority control indication transmitted from the SSW 30 via the IP network IPNW and the network interface module 72. In this OSS 40, the session priority change control module 76 determines a priority indication content for every network element by searching the network architecture management data storage module 90 via the network architecture management module 74, and gives the priority control indication about a priority control target voice packet to each of the network elements via the network element control module 75 and the network interface module 72.

This scheme, as in the first operational example, the voice quality enhancement function responding to the priority control target call to be provided.

<Third Operation>

In the SSW 30 environment that sets a high priority to a specified piece of IP session information with respect to each network element, if the call is judged to be a priority control target call under the priority control in the second operation described above, the call priority control module 37 determines the IP session information by searching the MG priority IP session management data storage module 55.

Based on the selected IP session information, the call control module 36 gives a preferential path connection indication to the MGs 20, 21 via the IP network IPNW through the media control module 35 and the IP/PSTN interface module 32.

This scheme enables providing of the voice quality enhancement function responding to the priority control target call without cooperating with the OSS 40.

<Fourth Operation>

The operation till the call control module 36 of the SSW 30 receives the call originating signal and determines the source/destination MGs, is the same as the second operation. Thereafter, on the occasion of setting the path to the source/destination MGs, the call priority control module 37 refers to the subscriber information priority control management data storage module 56, thereby determining whether the priority control is required.

He call priority control module 37 further gives the priority control indication to the OSS 40 via the IP network IPNW through the OSS interface control module 34 and the IP/PSYN interface module 32. The subsequent operation is the same as that on the side of the OSS 40 in the second operation.

This scheme makes it feasible to provide the call-by-call voice quality enhancement function responding to the specified subscriber.

<Fifth Operation>

In the second or fourth operation, the call priority control module 37 of the SSW 30, when judging that the call is the priority control target call, obtains an identifier for identifying the call on the side of the OSS 40 from a priority control identifier management data storage module 57.

The call priority control module 37 transmits the priority control indication to the OSS 40 via the IP network IPNW through the OSS interface control module 34 and the IP/PSTN interface module 32. Further, the call control module 36 saves a state of implementation of the priority control on the priority control saving data storage module 58 in a way that maps each state to the call.

The OSS 40 receives the priority control indication transmitted from the SSW 30 via the IP network IPNW and the network interface module 72. In this OSS 40, the session priority change control module 76 determines a priority indication content for every network element by searching the network architecture management data storage module 90 via the network architecture management module 74. The session priority change control module 76, after saving the determined priority control indication content on the priority control identifier management data storage module 92 via the priority control identifier management module 77, gives the priority control indication about a priority control target voice packet to each of the network elements via the network element control module 75 and the network interface module 72.

When terminating the call, the call control module 36 of the SSW 30 judges whether the processing is on the priority control by referring to the priority control saving data storage module 58. If on the priority control, the call control module 36 boots the call priority control module 37, and gives a priority control end indication to the OSS 40 via the IP network IPNW through the OSS interface control module 34 and the IP-PSTN interface module 32. Further, the call control module 36 boots the call priority control module 37 to have a priority control identifier released from the priority control identifier management data storage module 57.

The OSS 40 receives the priority control end indication transmitted from the SSW 30 via the IP network IPNW and the network interface module 72. In this OSS 40, the session priority change control module 76 queries the priority control identifier management data storage module 92 about the network element in the process of implementing the priority control via the priority control identifier management module 77. The session priority change control module 76 fetches, based on a result of this query, a priority control policy before the priority control from the network architecture management data storage module 90 via the network architecture management module 74, and changes the network element to the initial priority control policy.

This scheme enables an automatic return of the network element with its policy changed to the initial priority when terminating the call.

<Sixth Operation>

The OSS maintenance command control module 73 of the OSS 40 receives a policy change indication command of the network element from the IP network IPNW via the network interface module 72, and boots the priority control identifier management module 77.

The priority control identifier management module 77 judges whether the processing is on the priority control by referring to the priority control identification management data storage module 92, and sends a result of the judgement back. If on the priority control, the OSS maintenance command control module 73 changes only the network architecture management data in the network architecture management data storage module 90 via the network architecture management module 74.

A content of the changed data in the network architecture management data storage module 90 is, as in the case of the fifth operation discussed above, reflected in each network element under the control of the session priority change control module 76.

This scheme enables prevention of a service interruption due to the network element in the process of implementing the priority control and an unintended maintenance related to the IP session information.

<Seventh Operation>

In the case where the second or third or fourth operation is carried out, the call control module 36 of the SSW 30 boots the call priority control speech management module 38, and judges whether the quality exceeds a quality threshold value by referring to priority control threshold value data in the priority control threshold value data storage module 53.

If under the quality threshold value, the call control module 36 boots the call priority control speech management module 38, and determines an operation of the preset media gateway MG by searching the priority control decreasing time operational definition data storage module 52.

The call control module 36, based on the quality data of which the media gateway MG has notified, follows the operation of the predetermined media gateway MG and indicates this media gateway MG to establish a connection to a connection resource.

This scheme enables the subscriber (speaker) to be notified of an interruption of the voice communication service when the call in the process of undergoing the priority control can keep a specified level of quality.

[Specific Example of Operation of VoIP Network System]

Given next is an explanation of specific examples of a variety of operations in the call priority process and the policy change process subsequent thereto in the VoIP network system SYS shown in FIG. 1.

<First Specific Operational Example (Related to Above First and Second Operations)>

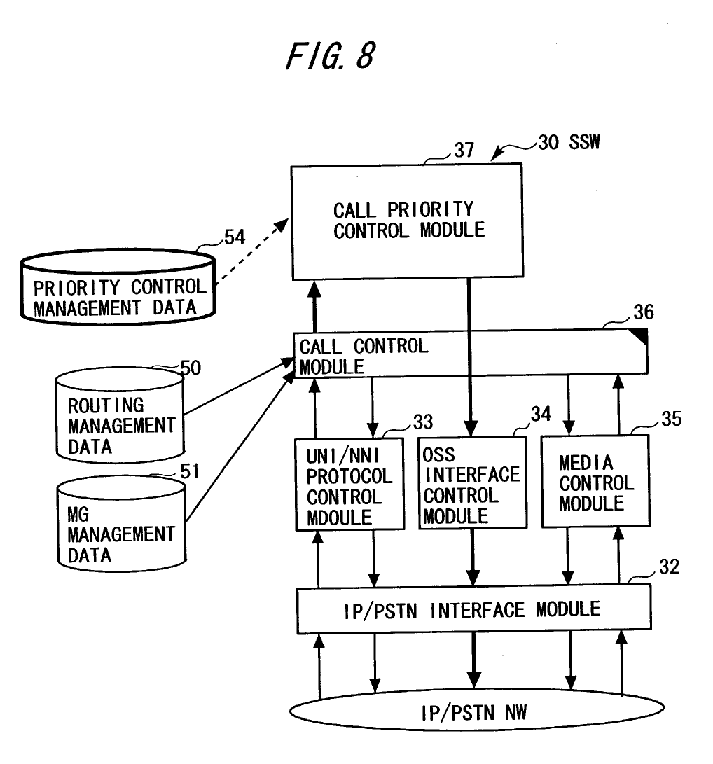

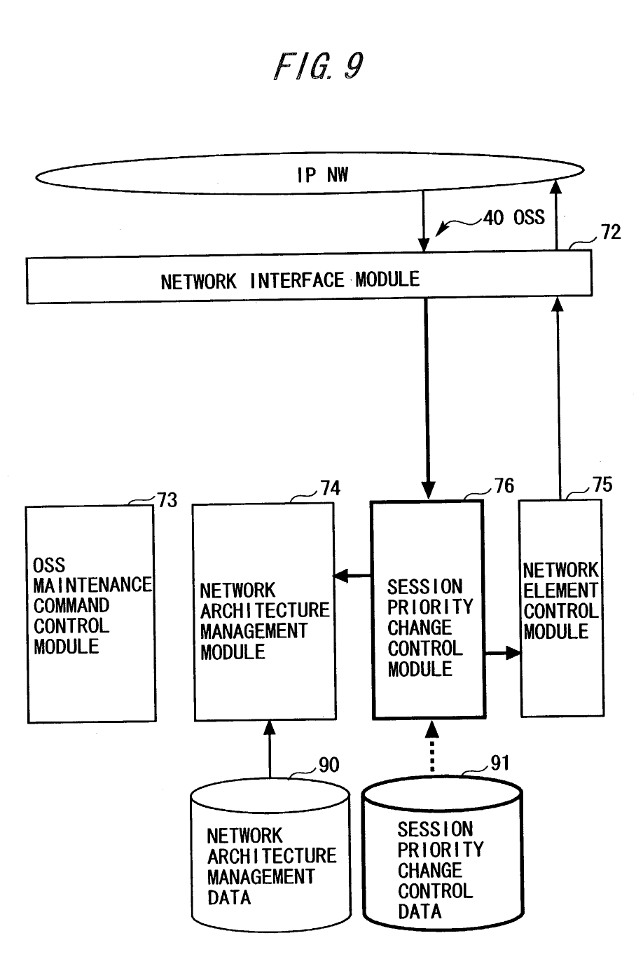

Referring to FIGS. 1, 8 and 9 in combination, when the subscriber terminal SUB-A under the circuit switch 10 originates a call to the subscriber terminal SUB-B under the circuit switch 11, the circuit switch 10 transmits the call control signal based on SS7 over the Common Channel Signaling network (which will hereinafter be referred to as an SS7 (ISUP) control signal) to the SSW 30.

The call control module 36 of the SSW 30 receiving this SS7 (ISUP) control signal (call originating signal) searches the routing management data storage module 50 in a way that uses as a key a piece of circuit switch information (an address of the circuit switch 10) of the call originating side (source side) circuit switch which is contained in the SS7 (ISUP) control signal, thereby determining the MG 20 as a source MG.

The call control module 36 likewise searches the routing management data storage module 50 in a way that uses, as keys, pieces of circuit switch information of the call receiving side (callee side) circuit switch which is contained in the SS7 (ISUP) control signal, thereby determining the call receiving side (called side) circuit switch 11 and the MG 21 as a destination MG, respectively.

Further, the call control module 36 searches the MG management data storage module 51 and thus determines an unoccupied line between the circuit switch 11 and the MG 21.

The call control module 36 boots the media control module 35 indicates the source MG 20 and the destination MG 21 to establish a path connection based on the H.248 (AMEGACO) signal and receives a result of this connection.

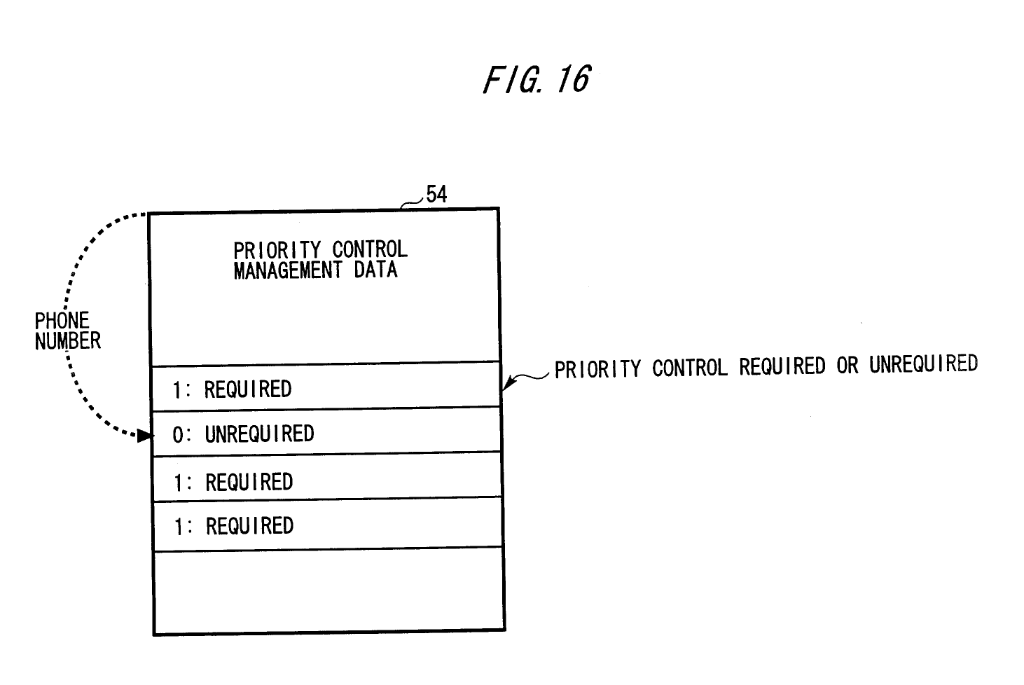

Further, the call control module 36 boots the call priority control module 37 and judges whether the target call is categorized as a priority control call. In this case, the call priority control module 37 searches the priority control management data storage module 54 (FIG. 16) by using, as keys, pieces of number information (such as a phone number (callee phone number) of the call receiving side subscriber terminal, source/destination MG addresses and source/destination port numbers) set in the SS7 (ISUP) control signal, thereby determining whether the priority control is needed.

The call priority control module 37, if the priority control is needed, gives the priority control indication to the OSS 40 via the IP network IPNW through the OSS interface control module 34 and the IP/PSTN interface module 32.

In the OSS 40 receiving the priority control indication from the SSW 30, the session priority change control module 76 actually receiving this indication boots the network architecture management module 74, and searches the network architecture management data storage module 90, thereby extracting addresses of the network elements managed.

The session priority change control module 76 obtains a priority control indication content (e.g., a packet having a source address a (mapped to the phone number of the source subscriber terminal) is placed into a high-priority queue) for every network element by searching the session priority change control data storage module 91 with the extracted network element address used as a key. Then, the session priority change control module 76 gives a change of the priority to the network element via the IP network IPNW through the network element control module 75 and the network interface module 72.

This scheme makes it possible to provide the voice quality enhancement function for the priority control target call when performing the voice communications based on the VoIP service from the subscriber terminal SUB-A under the circuit switch 10 to the subscriber terminal SUB-B under the circuit switch 11.

<Second Specific Operational Example (Related to Above First, Second and Fourth Operations)>

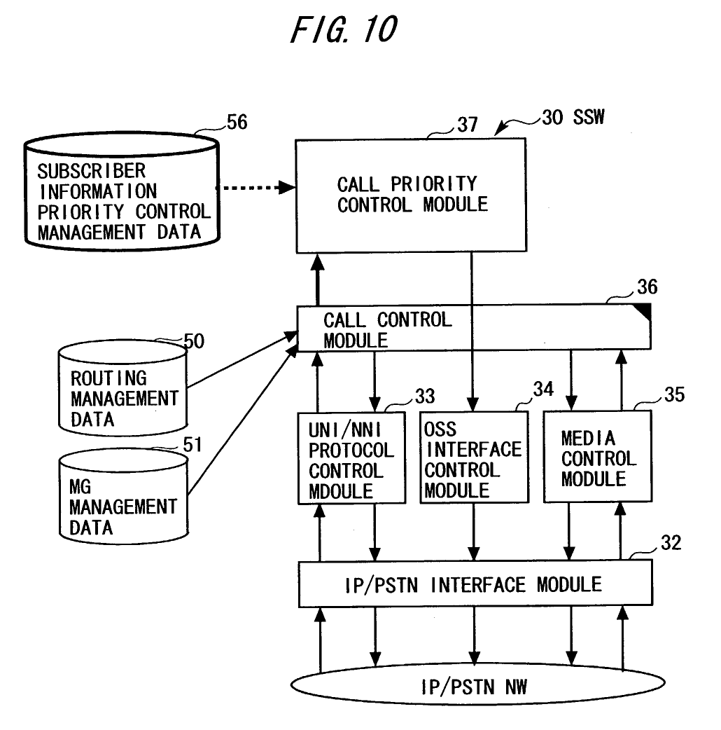

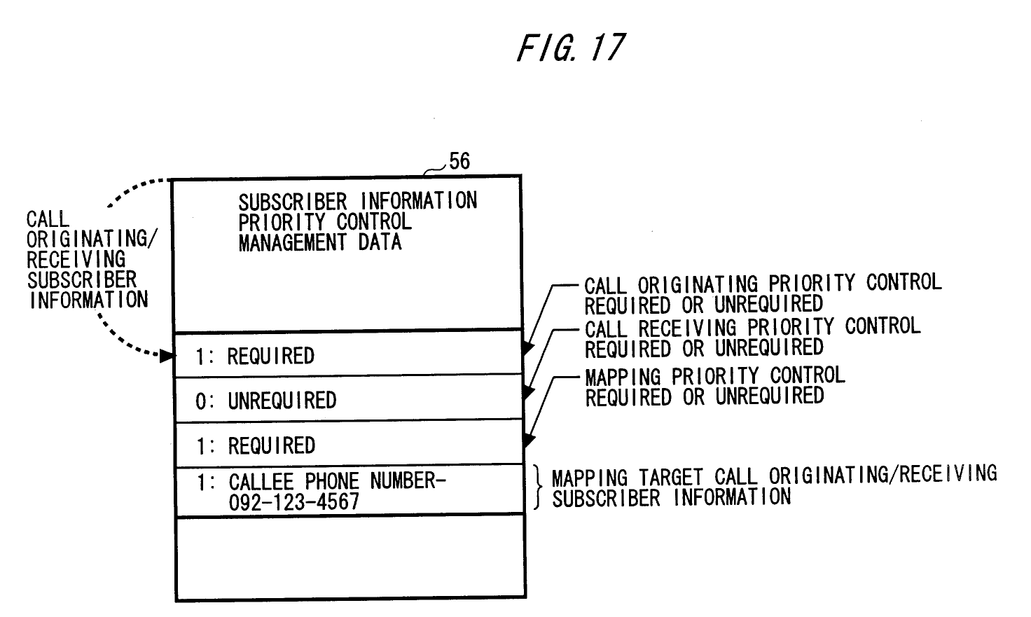

Referring to FIGS. 1 and 10 in combination, the call priority control module 37 of the SSW 30 judges whether the priority control is required or not by searching the subscriber information priority control management data storage module 56 (FIG. 17), wherein pieces of subscriber information (source/destination subscriber information, source/destination MG addresses, source/destination port numbers) set in the SS7 (ISUP) control signal in addition to the number information used in the first specific operational example described above. The subsequent operations are the same as those in the first specific operational example explained above.

Herein, the subscriber information priority control management data storage module 56 manages pieces of call originating/receiving time priority control necessity judging information (required/unrequired) and information for recognizing a piece of specified mapping target subscriber information (e.g., a receiving phone number: 092-123-4567).

This scheme makes it possible to provide the voice quality enhancement function for the specified target call when performing the voice communications based on the VoIP service from the subscriber terminal SUB-A under the circuit switch 10 to the subscriber terminal SUB-B under the circuit switch 11.

<Third Specific Operational Example (Related to Above First, Second and Third Operations)>

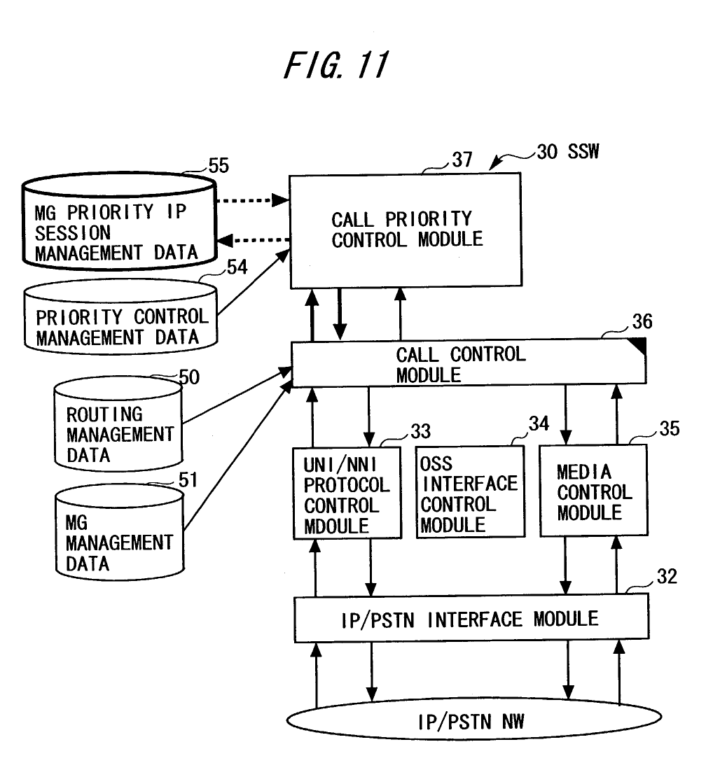

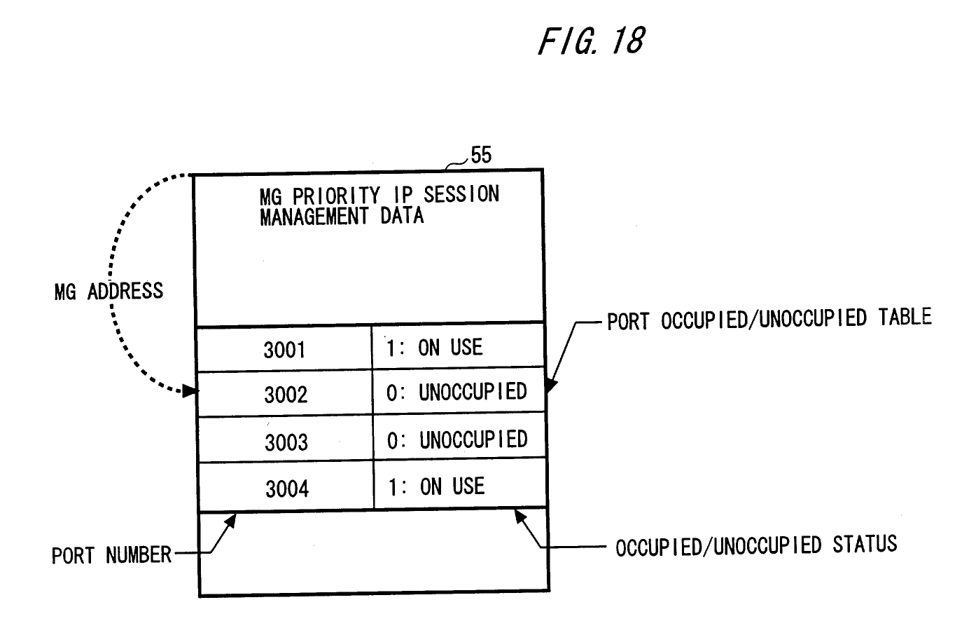

Referring to FIGS. 1 and 11 in combination, the call priority control module 37 of the SSW 30 captures, when judging that the call is categorized as the priority control target call in the first specific operational example described above, a statistically pre-allocated port number for the priority control by searching the MG priority IP session management data storage module 55 (FIG. 18) with the MG address used as a key, and sets “1” indicating an on-use state in an occupied/unoccupied flag of an occupied/unoccupied port number table on the MG priority IP session management data storage module 55.

Thereafter, the call control module 36 boots the media control module 35, and gives a past connection indication carried on the H.248 (MEGACO) signal to the source MG 20 and the destination MG 21, and receives a result of this connection.

When terminating the priority control call, the SSW 30 receives a SS7 (ISUP) control signal (a call termination signal) transmitted from the source circuit switch 10 or the destination circuit switch 11 through the IP-PSTN interface module 32 and the UNI/NNI protocol control module 33. The call control module 36 in this SSW 30 boots the call priority control module 37 and, with the source/destination MG addresses and the source/destination port numbers serving as inputs, releases the port number (related to the call termination signal) used on the MG priority IP session management data storage module 55.

This scheme makes it feasible to provide the voice quality enhancement function for the priority control target call without operating the OSS 40 when performing the voice communications based on the VoIP service from the subscriber terminal SUB-A under the circuit switch 10 to the subscriber terminal SUB-B under the circuit switch 11.

<Fourth Specific Operational Example (Related to Above First, Second and Fifth Operations)>

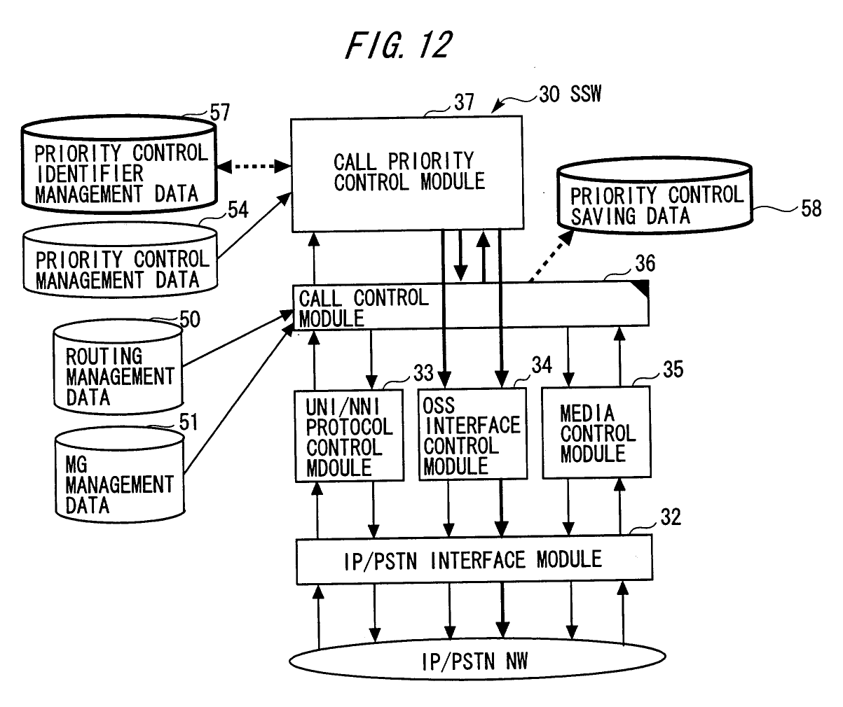

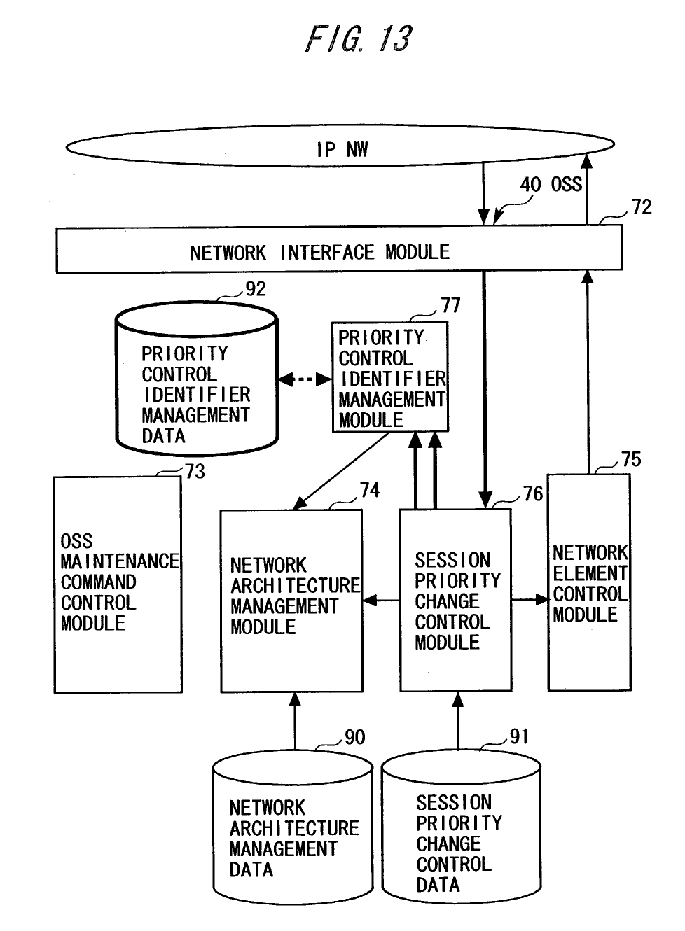

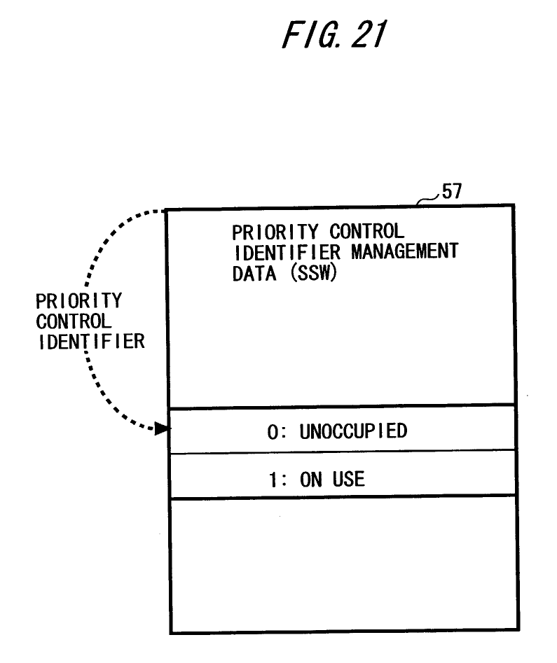

Referring to FIGS. 1, 12 and 13 in combination, the call priority control module 37 of the SSW 30 obtains, when judging that the call is categorized as the priority control target call in the first specific operational example described above, an identifier for identifying the call from the priority control identifier management data storage module 57 (FIG. 21), i.e., captures identifiers of the calls each showing an unoccupied state by searching the priority control identifier management data storage module 57. Then, the call priority control module 37 set a data-wise status (flag) to the on-use state, and gives the priority control indication by transmitting the priority control identifier, the source/destination MG addresses and the source/destination port numbers to the OSS 40 via the IP network IPNW through the OSS interface control module 34 and the IP/PSTN interface module 32.

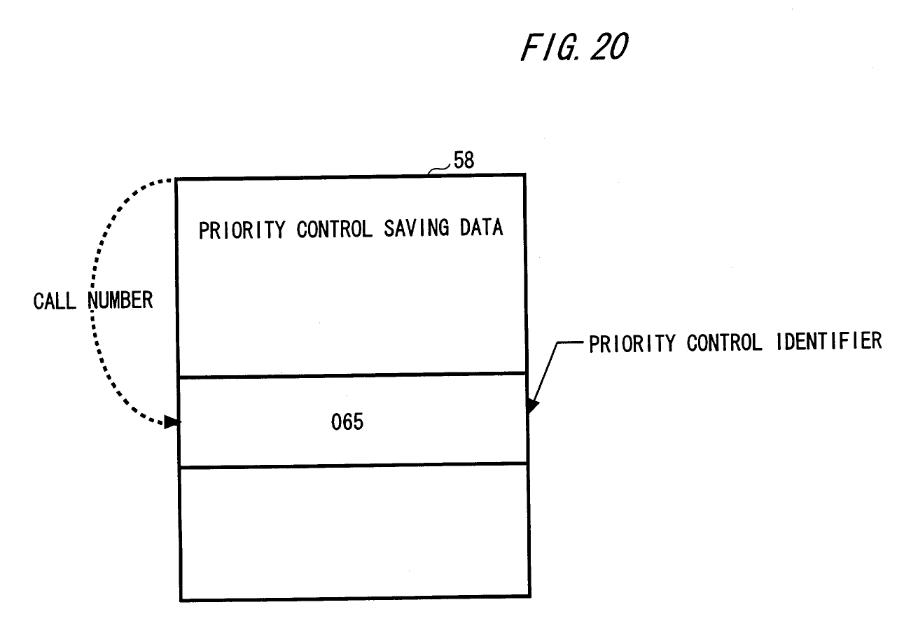

Thereafter, the call control module 36, for managing a state of implementation of the priority control on a mapping-to-call basis, saves the priority control identifier (e.g., 065) mapping to the call number on the priority control saving data storage module 58 (FIG. 20). Further, the call control module 36 transmits the SS7 (ISUP) control signal (call originating signal) to the destination circuit switch 11 via the public-switched telephone network PSTNNW through the UNI/NNI protocol control module 33 and the IP/PSTN interface module 32.

The OSS 40 receives the priority control indication transmitted from the SSW 30 via the IP network IPNW and the network interface module 72. In this OSS 40, the session priority change control module 76 boots the network architecture management module 74, and extracts the addresses of managed the network elements by searching the network architecture management data storage module 90.

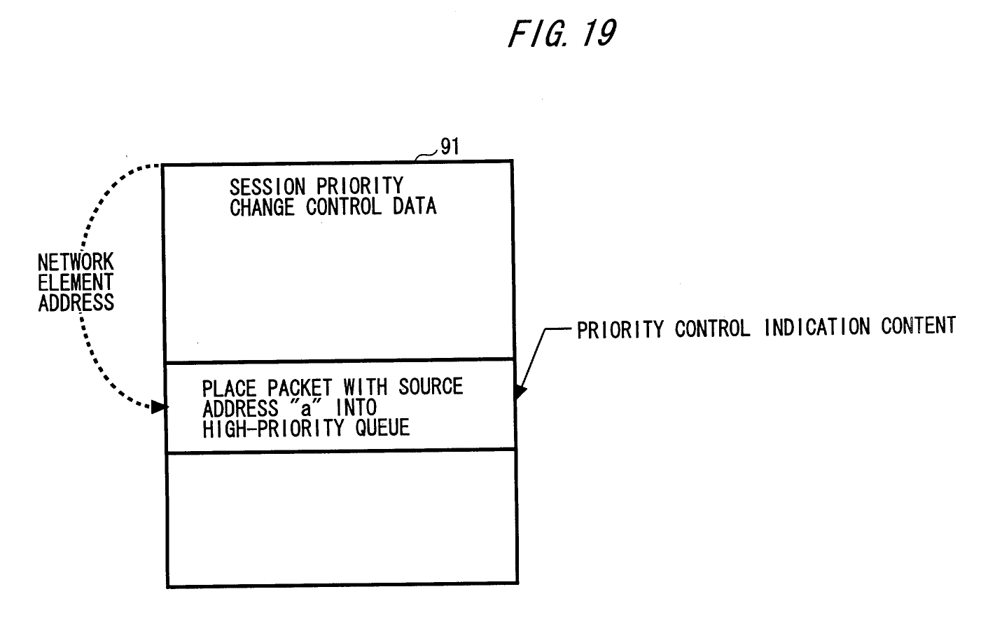

The session priority change control module 76 obtains a priority indication content for every network element by searching the session priority change control data storage module 91 (FIG. 19), and indicates the network elements to change the priority via the IP network IPNW through the network element control module 75 and the network interface module 72.

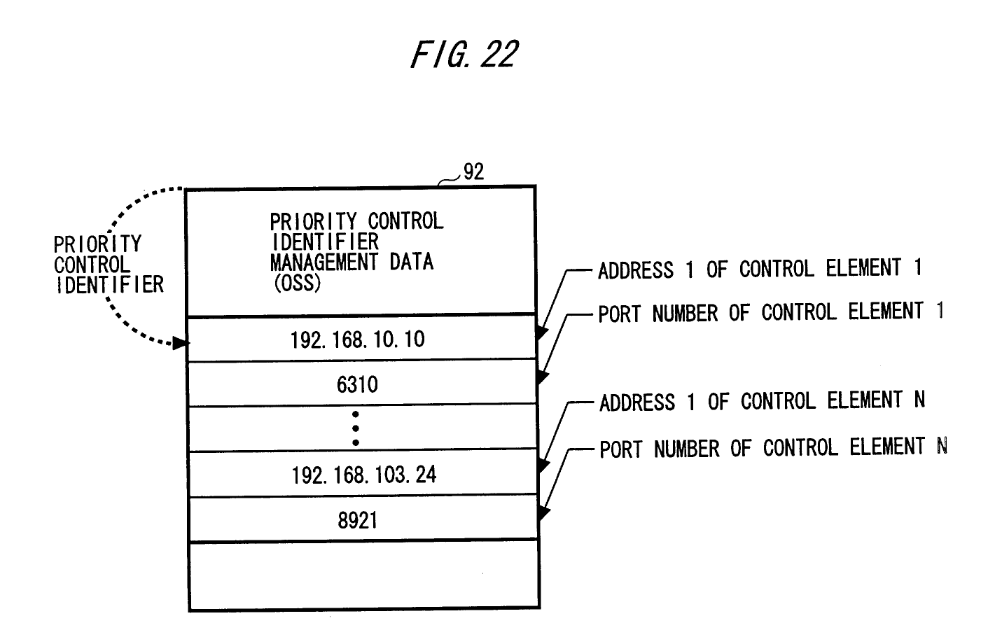

Further, the priority control identifier management module 77, in response to the indication given from the session priority change control module 76, saves the priority control identifier and the addresses and port numbers of the controlled network elements as contents of the priority change control in a way that maps these pieces of data to the priority control identifiers on the priority control identifier management data storage module 92 (FIG. 22).

Owing to a series of processes described above, the subscriber terminal SUB-A under the source circuit switch 10 can perform the voice communications based on the VoIP service with the subscriber terminal SUB-B under the destination circuit switch 11.

When terminating the voice communications between the subscriber terminal SUB-A and the subscriber terminal SUB-B, the call control module of the SSW 30 receiving the SS7 (ISUP) control signal (call terminating signal) from the circuit switch 10 or 11 on the public-switched telephone network PSTNNW, judges whether the processing is on the priority control by searching the priority control saving data storage module 58 (FIG. 20) with the call number used as a key.

The call control module 36, if on the implementation of the priority control, boots the call priority control module 37 with the priority control identifier serving as an input, and indicates the OSS interface control module 34 to terminal the priority control, thereby releasing the priority control identifier.

In the OSS 40 receiving the priority control indication from the SSW 30 via the IP network IPNW, the session priority change control module 76 actually receiving this indication boots the priority control identifier management module 77, and searches the priority control identifier management data storage module 92 (FIG. 22), thereby obtaining an address and a port number of the network element that is on the implementation of the priority control mapping to the priority control identifier.

Further, the session priority change control module 76 boots the network architecture management module 74, and extracts a policy before implementing the priority control by searching the network architecture management data storage module 90 with the previously obtained address and port number used as keys.

The session priority change control module 76 indices the network element concerned to change the priority via the IP network IPNW through the network element control module 75 and the network interface module 72.

This scheme enables the network element having implemented the priority control to automatically revert to its initial state of the priority control.

<Fifth Specific Operational Example (Related to Above First, Second, Fifth and Sixth Operations)>

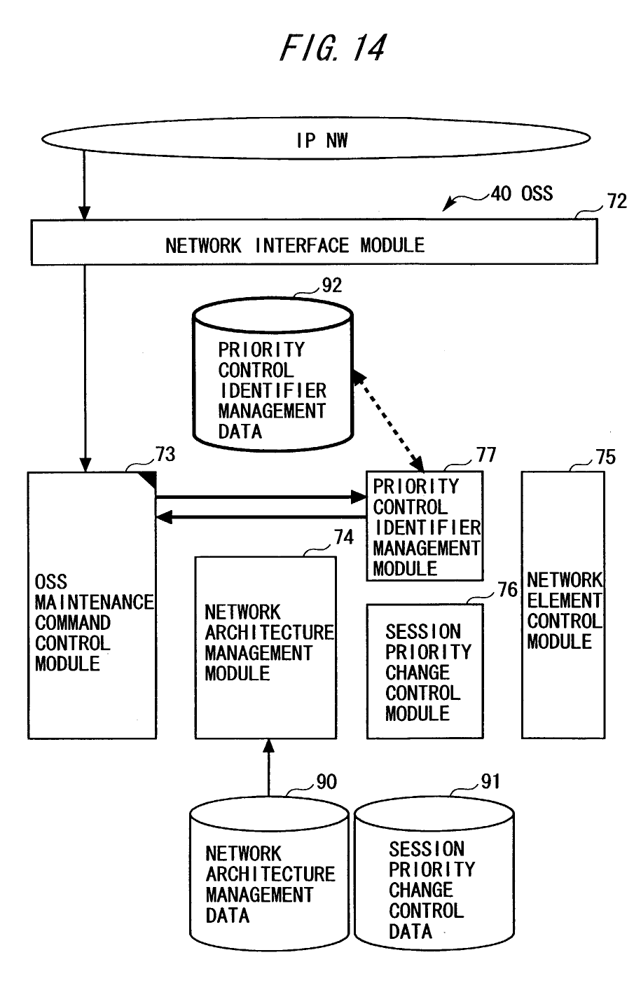

Referring to FIGS. 1 and 14 in combination, in the OSS 40 in the fourth specific operational example described above, when the subscriber terminal SUB-A under the source circuit switch 10 and the subscriber terminal SUB-B under the destination circuit switch 11 are performing the communications with each other under the priority control using a certain network element, it is assumed that a maintenance person makes the priority change of this network element.

The OSS maintenance command control module 73 receiving a policy change indication command of the network element from the maintenance person via the IP network IPNW, boots the priority control identifier management module 77, and judges whether the change target network element is on the priority control by having the priority control identifier management data storage module 92 (FIG. 22) searched. Namely, the priority control identifier management data storage module 92 manages the address and the port number of the control element implementing the priority control, and hence the OSS maintenance command control module 73 can make the above judgement by referring to these pieces of data.

As a result of this, the OSS maintenance command control module 73 makes the maintenance person suspend the process if on the priority control or sends back to the maintenance person a message saying that the priority control can not be changed.

This scheme enables prevention of the service interruption unintended by the maintenance person.

<Sixth Specific Operational Example (Related to Above First, Second, Fifth and Seventh Operations)>

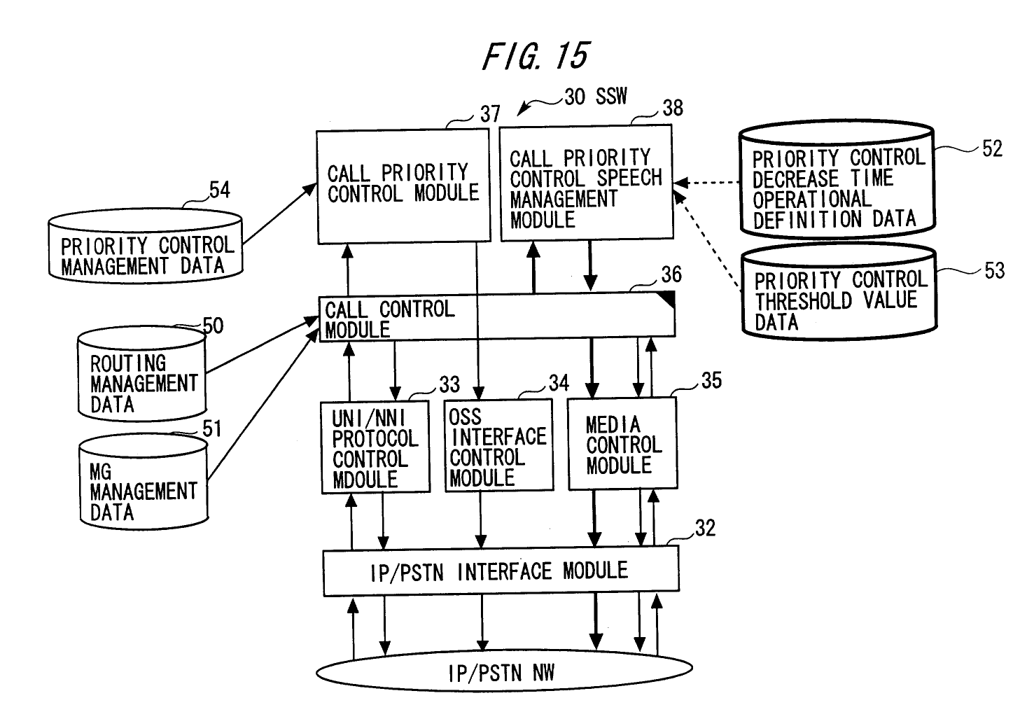

Referring to FIGS. 1 and 15 in combination, in the first specific operational example described above, when the subscriber terminal SUB-A under the source circuit switch 10 and the subscriber terminal SUB-B under the destination circuit switch 11 are performing the communications with each other under the priority control, it is assumed that the SSW 30 receives voice packet quality information transmitted based on RTCP (Real-Time Control Protocol) from the source MG 20. Herein, RTCP is defined as a control protocol for RTP (Real-time Transport Protocol).

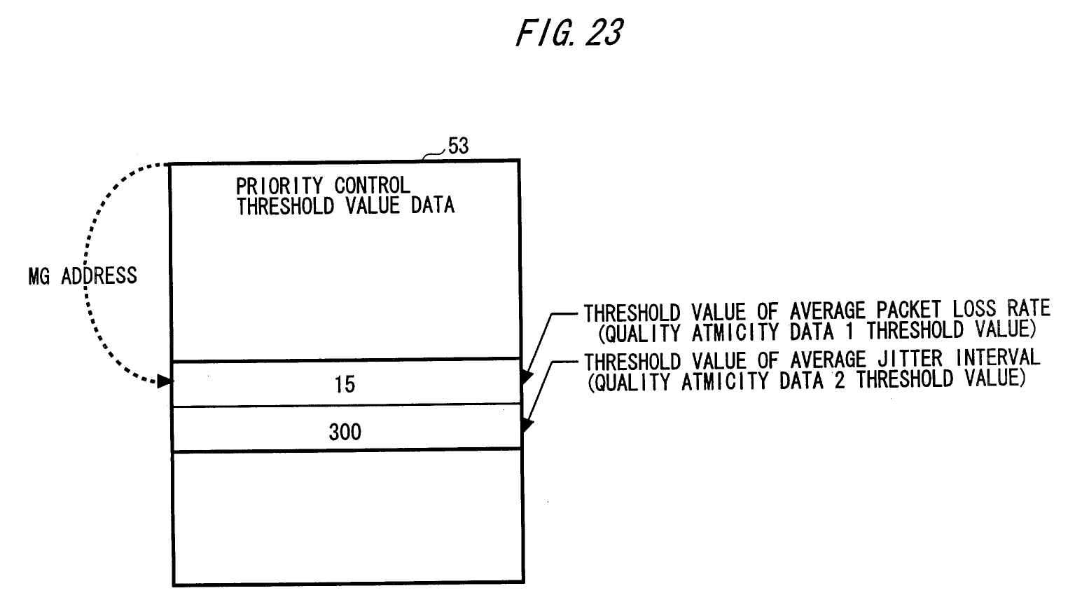

The call control module 36 receiving the voice packet quality information (such as quality atomicity data, a packet discard rate etc), boots the call priority control speech management module 38. The call priority control speech management module 38 searches the priority control threshold value data storage module 53 (FIG. 23) by using the MG address as an index.

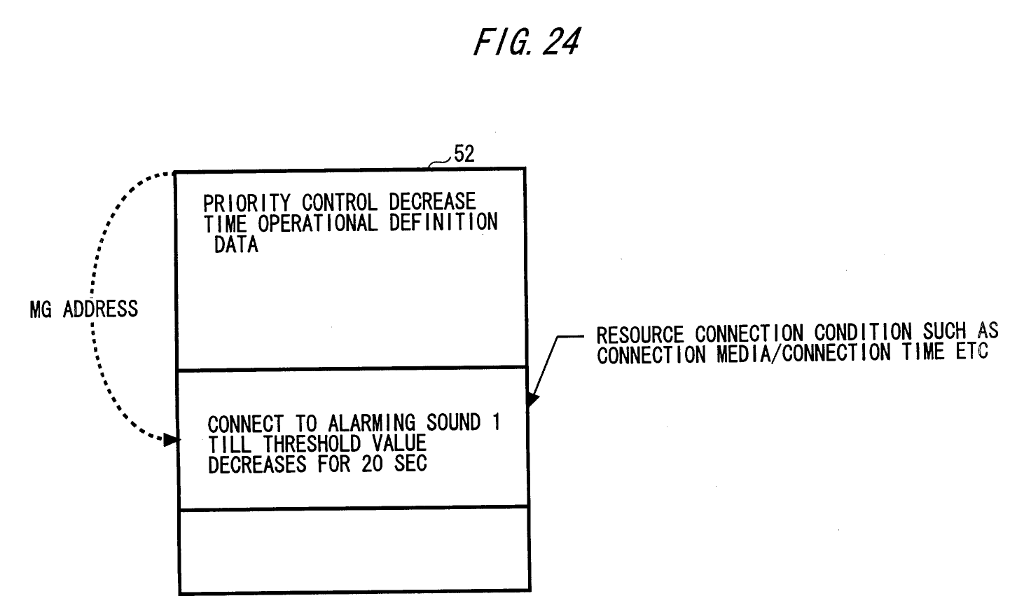

The call priority control speech management module 38, if it is judged that there are decreases in threshold value of an average packet loss rate and threshold value of an average jitter interval as the priority control threshold value data, searches the priority control decreasing time operational definition data storage module 52 (FIG. 24) by using the MG address as the index, thereby determining MG connection resource conditions (connection media, a connection time etc) when the operation decreases. Then, the call priority control speech management module 38 sends these resource conditions back to the call control module 36.

The call control module 36, based on priority control decrease operational conditions corresponding to the sent-back MG connection resource conditions, establishes at one connection to the MG 20 receiving the voice packet quality information based on RTCP, an makes the MG 20 gives an alarming sound to the subscriber.

The subscriber can be thereby notified that the call in the process of undergoing the priority control can not keep a specified level of quality.

### MODIFIED EXAMPLE

The respective processes described above can be provided as a program executable by a computer, and the program can be recorded on a recording medium such as a CD-ROM, a flexible disk etc and can be also distributed via communication lines.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. A VoIP network system comprising:
a module controlling a transmission of a priority control indication corresponding to a call control signal for every call and to priority control information preset for providing a VoIP-based voice communication service in a way that specifies a priority control target call related to a specified voice session; and
a module giving a priority control indication about a voice packet of the priority control target call to each of network elements, configuring an IP network, for forwarding the voice packet.

2. A VoIP network system for providing a VoIP-based voice communication service by forwarding a voice packet over an IP network, said system comprising:
a module judging whether a call is a priority control target call related to a specified voice session on the basis of call originating number information contained in a call control signal transmitted from a source network accommodating a call originating terminal, and, when judging that the call is the priority control target call, controlling a transmission of a priority control indication;
a module searching storage data for managing the priority control with the indicated number information used as a key, and transmitting a signal for making a priority control request about IP session information used for the voice session of the priority control target call; and
a module giving a control indication for operating network elements of the IP network on the basis of the storage data for control of session priority change when receiving a priority control request signal for the priority control target call.

3. A VoIP network system according to claim 2, further comprising:
a module selecting, when judging that the call is the priority control target call, high-priority IP session information by searching the storage data for managing preferential IP sessions in an environment where a high priority is set in a specified item of IP session information in said network elements; and
a module indicating said network element to establish a path connection in the IP network on the basis of the selected IP session information.

4. A VoIP network system according to claim 2, further comprising:
a module transmitting subscriber information in the call originating number information contained in the call control signal in order to give the priority control indication for the priority control target call; and
a module making a judgement about the priority control target call by searching the storage data for a priority control management with the received subscriber information used as a key.

5. A VoIP network system according to claim 2, further comprising:
a first storage module managing a priority control identifier for identifying the priority control target call;
a second storage module managing a priority control implementation status in a way that maps this status to the priority control identifier for every call;
a setting/searching module setting and searching management data of said storage module when originating a call and when terminating the call;
a module booted by said setting/searching module when originating the call and when terminating the call, controlling an acquisition and a transmission of the priority control identifier, and controlling a transmission of a priority control terminating indication when terminating the call;
a third storage module managing a mapping of a priority change to said network element on the basis of the received priority control identifier;
a module setting management data on said third storage module when receiving the priority control indication, specifying said network element on the basis of the received priority control identifier and the priority control identifier management data stored on said third storage module when receiving the priority control terminating indication, and extracting an initial priority control policy of said specified network element from storage data for managing a network architecture; and
a module effecting a session priority change for making a priority policy change request when receiving the priority control terminating indication.

6. A VoIP network system according to claim 5, further comprising:
a module booted when making a change due to a maintenance with respect to the priority policy related to the IP session information and, if said indicated network element is in the process of the priority control, managing a priority control identifier used for sending this purport back; and
a module judging whether a requested maintenance-based change can be done by querying said priority control identifier management module, and changing only the network architecture management storage data when on the implementation of the priority control.

7. A VoIP network system according to claim 2, further comprising:
a management module judging whether a voice packet quality exceeds a preset quality threshold value by referring to priority control threshold value data when notified of the voice packet quality of the priority control target call undergoing the implementation of the priority control that is transmitted from said network element having a function of notifying the voice packet quality, determining an operation of said preset network element by referring to a priority control decrease time operational definition data, and sending a content of this operation back; and
a module notifying said management module of the voice packet quality of which said network element has notified, and controlling a priority control decrease time operation of said network element on the basis of the operation content sent back.

8. A priority control target call processing system comprising:
a module controlling a transmission of a priority control indication corresponding to a call control signal for every call and to priority control information preset for providing a VoIP-based voice communication service in a way that specifies a priority control target call related to a specified voice session; and
a module giving a priority control indication about a voice packet of the priority control target call to each of network elements, configuring an IP network, for forwarding the voice packet.

9. A priority control target call processing method comprising:
controlling a transmission of a priority control indication corresponding to a call control signal for every call and to priority control information preset for providing a VoIP-based voice communication service in a way that specifies a priority control target call related to a specified voice session; and
giving a priority control indication about a voice packet of the priority control target call to each of network elements, configuring an IP network, for forwarding the voice packet.

10. A priority control target call processing method in a VoIP network system for providing a VoIP-based voice communication service by forwarding a voice packet over an IP network, said method comprising:
judging whether a call is a priority control target call related to a specified voice session on the basis of call originating number information contained in a call control signal transmitted from a source network accommodating a call originating terminal, and, when judging that the call is the priority control target call, controlling a transmission of a priority control indication;
searching storage data for managing the priority control with the indicated number information used as a key, and transmitting a signal for making a priority control request about IP session information used for the voice session of the priority control target call; and
giving a control indication for operating network elements of the IP network on the basis of the storage data for control of session priority change when receiving a priority control request signal for the priority control target call.

11. A priority control target call processing method in a VoIP network system according to claim 10 further comprising:
selecting, when judging that the call is the priority control target call, high-priority IP session information by searching the storage data for managing preferential IP sessions in an environment where a high priority is set in a specified item of IP session information in said network elements; and
indicating said network element to establish a path connection in the IP network on the basis of the selected IP session information.

12. A priority control target call processing method in a VoIP network system according to claim 10, further comprising:
transmitting subscriber information in the call originating number information contained in the call control signal in order to give the priority control indication for the priority control target call; and
making a judgement about the priority control target call by searching the storage data for a priority control management with the received subscriber information used as a key.

13. A priority control target call processing method in a VoIP network system according to claim 10, further comprising:
storing for management a priority control identifier for identifying the priority control target call;
storing for management a priority control implementation status in a way that maps this status to the priority control identifier for every call;
setting and searching management data of said storage module when originating a call and when terminating the call;
being booted when originating the call and when terminating the call, controlling an acquisition and a transmission of the priority control identifier, and controlling a transmission of a priority control terminating indication when terminating the call;
storing for management a mapping of a priority change to said network element on the basis of the received priority control identifier;
setting management data when receiving the priority control indication, specifying said network element on the basis of the received priority control identifier and the stored priority control identifier management data when receiving the priority control terminating indication, and extracting an initial priority control policy of said specified network element from storage data for managing a network architecture; and
effecting a session priority change for making a priority policy change request when receiving the priority control terminating indication.

14. A priority control target call processing method in a VoIP network system according to claim 13, further comprising:
being booted when making a change due to a maintenance with respect to the priority policy related to the IP session information and, if said indicated network element is in the process of the priority control, managing a priority control identifier used for sending this purport back; and
judging whether a requested maintenance-based change can be done by querying said priority control identifier management module, and changing only the network architecture management storage data when on the implementation of the priority control.

15. A priority control target call processing method in a VoIP network system according to claim 10, further comprising:
judging whether a voice packet quality exceeds a preset quality threshold value by referring to priority control threshold value data when notified of the voice packet quality of the priority control target call undergoing the implementation of the priority control that is transmitted from said network element having a function of notifying the voice packet quality, determining an operation of said preset network element by referring to a priority control decrease time operational definition data, and sending a content of this operation back; and
notifying said management module of the voice packet quality of which said network element has notified, and controlling a priority control decrease time operation of said network element on the basis of the operation content sent back.

16. A readable-by-computer recording medium recorded with a program executed by a computer, said program comprising:
controlling a transmission of a priority control indication corresponding to a call control signal for every call and to priority control information preset for providing a VoIP-based voice communication service in a way that specifies a priority control target call related to a specified voice session; and
giving a priority control indication about a voice packet of the priority control target call to each of network elements, configuring an IP network, for forwarding the voice packet.
